(19) United States
(12) Patent Application Publication
(10) Pub. No.: US 2014/0087232 A1
(43) Pub. Date: Mar. 27, 2014

(54) Black Polyimide Battery Label

(71) Applicant: Avery Dennison Corporation, Pasadena, CA (US)

(72) Inventors: Yihua WANG, Kunshan (CN); Jun ZHANG, Kunshan (CN); XinHui ZHANG, Kunshan (CN)

(73) Assignee: Avery Dennison Corporation, Pasadena, CA (US)

(21) Appl. No.: 13/972,088

(22) Filed: Aug. 21, 2013

(30) Foreign Application Priority Data
Sep. 25, 2012 (CN) PCT/CN2012/081885

(51) Int. Cl. C09J 7/02; G09F 3/10

(52) U.S. Cl. CPC C09J 7/0264; C09J 7/0217; G09F 3/10
USPC 429/122; 428/343; 428/337; 428/354; 428/336; 428/355 AC; 428/356; 428/334

(57) ABSTRACT

A battery label having a black appearance and exhibiting flame retardancy properties is described.

### BACKGROUND

The present subject matter relates to battery labels and particularly, to black labels comprising polyimides.

### SUMMARY OF THE INVENTION

The difficulties and drawbacks associated with previously known battery labels are addressed in the present labels and labeled batteries.

In one aspect, a battery label is provided comprising a polyimide substrate defining an outer face and an oppositely directed inner face. The battery label also comprises a layer of a flame retardant pressure sensitive adhesive disposed on the inner face of the polyimide substrate.

In another aspect, a battery and label applied thereto are provided which comprise a battery having an outer surface, and the previously noted battery label adhesively attached to the outer surface of the battery.

In another aspect, a multilayer flame retardant battery label exhibiting a black appearance and free of inks, coatings, or paints which are black in color is provided.

As will be realized, the subject matter described herein is capable of other and different embodiments and its several details are capable of modifications in various respects, all without departing from the claimed subject matter. Accordingly, the drawings and description are to be regarded as illustrative and not restrictive.

### DETAILED DESCRIPTION OF THE EMBODIMENTS

Labels for batteries such as for portable electronic devices must address various demands such as the labels should be thin yet exhibit relatively high tensile strength, should exhibit high temperature resistance and dimensional stability, should be flame retardant, and should exhibit electrical insulative properties. Various multilayer battery labels are described herein that address these objectives. Generally, a multilayer flame retardant battery label is provided that exhibits a black appearance and is free of inks, coatings, or paints which are black in color.

A representative embodiment multilayer battery label is provided comprising (i) a black polyimide substrate layer defining an outer face and an inner face, (ii) a top coat or primer layer on the outer face of the substrate layer, and (iii) a flame retardant adhesive disposed on the inner face of the substrate layer. A liner is typically applied along the exposed face of the adhesive.

### Substrate

The substrate layer is formed from a polyimide material having an effective amount of carbon black dispersed therein. Typically, polyimide materials are yellow in color. The representative embodiment battery labels use a polyimide material for the substrate layer which is black in color and which results from incorporation of particulate carbon black in the polyimide material. Thus, in certain embodiments, the substrate layers are free of coating or inks applied to their outer surface to impart a color or blackening of the substrate. Instead, the polyimide substrates of the representative battery labels are black without any applied coloring coatings. Furthermore, in certain embodiments, the polyimide substrates exhibit a black color or appearance within various regions of their cross section. In certain embodiments, the carbon black is well dispersed in a prepolymer before reaction to form the polyimide substrate.

In certain instances, it has been observed that after incorporation of carbon black into a prepolymer composition that subsequently forms the polyimide substrate, the carbon black tends to accumulate along one face of the resulting polyimide substrate. Although not wishing to be bound to any particular theory, it is believed that an increase in temperature of the composition which occurs during polymerization and/or extruding of the layer results in accumulation of the carbon black in certain regions of the polyimide substrate. In such instances, one face of the resulting substrate may exhibit a matte black appearance, and the oppositely directed face may exhibit a glossy appearance.

A wide array of polyimides can be used for the substrate layer of the battery labels described herein. A representative polyimide composition for use in the battery labels described herein is set forth below in Table 1.

TABLE 1
Representative
Polyimide Composition

| | | | CAS |
|---|---|---|---|
| Component | Weight % | Description | No. |
| A | 46-48% | Pyromellitic | 89-32-7 |
| | | Dianhydride | |
| | | (PMDA) | |
| B | 50-52% | 4,4′-Oxydianiline | 101-80-4 |
| | | (ODA) | |
| C | 1-2% | Carbon Black | N/A |

Component A is a carboxylic acid anhydride having a chemical formula of C₆H₂(C₂O₃)₂. Component A is pyromellitic dianhydride (PMDA) and is also known as 1,2,4,5-benzenetetracarboxylic dianhydride.

Component B has a chemical formula of O(C₆H₄NH₂)₂, and is an ether derivative of aniline. Component B is also known as 4,4′-diaminodiphenyl ether.

Components A and B are polymerized to form a polyimide composition. Component C is dispersed within the composition prior to, during, or after polymerization.

Carbon black is commercially available from numerous sources and in many different grades. Typical carbon black for use in the substrate layers of the battery labels described herein include nanometer sized particles of carbon black.

Although carbon black is noted for incorporating in the polyimide composition in order to impart a black color to the composition and other desirable properties to a substrate formed from the composition, it is contemplated that other agents can be used such as for example inorganic pigments and colorants. The proportion of the carbon black and/or other agents incorporated in the polyimide composition depends upon the particular application. However, typical weight percentages range from about 0.1% to about 5%, with 1% to 2% being useful for many embodiments.

The polyimide layer has a thickness depending upon the end use requirements of the battery label. For applications in which high tensile strength is required, the polyimide layer has a thickness of from about 35 μm to about 42 μm, with 38 μm being typical. For other applications in which thinness of the battery label is desired, the polyimide layer is from about 13 μm to about 17 μm, with 15 μm being typical.

### Top Coat or Primer

One or more layers of a top coat or primer are typically disposed on the outer face of the polyimide substrate. The top coat can be clear or substantially so. In certain embodiments, the top coat has a matte or textured surface or appearance. The top coat is generally adapted to receive and retain indicia printed thereon. A wide array of indicia application techniques can be used such as letterpress, silk screening, fleox, printing, and the like.

The top coat or primer layer typically has a thickness of from about 0.5 μm to about 5 μm. It will be appreciated that the battery labels may utilize top coats or primer layers having thicknesses greater than or less than these values.

### Flame Retardant Adhesive

An adhesive, and typically a pressure sensitive adhesive, is disposed on the inner face of the polyimide substrate. Generally, a wide range of adhesives can be used in the preferred battery labels described herein so long as the adhesive exhibits flame retardant properties. In certain embodiments, the flame retardant adhesives are pressure sensitive acrylic adhesives. One or more flame retardant agents or additives can be incorporated in the adhesive to render the adhesive flame retardant or promote the flame retardant properties of the adhesive.

The acrylic based adhesives are selected from the commercially available “S” and “SP” series from Avery Dennison Corporation; AEROSET adhesives from Ashland Chemical; DURO-TAK adhesives from Henkel Corporation; GELVA GMS adhesives available from Cytec; and ORIBAIN adhesives from Toyo Ink.

Flame retardant agents include, but are not limited to, metal oxide hydrates, polyphosphates, melamines, polysiloxanes, organic phosphonates, and combinations thereof. Examples of suitable metal oxide hydrates include magnesium hydroxide and aluminum hydroxide. Examples of suitable polyphosphates include ammonium polyphosphate. Examples of suitable melamines include melamine phosphate. And examples of suitable polysiloxanes include SFR100 which is commercially available from Momentive Performance Materials. A wide array of commercially available flame retardant agents can be incorporated in the adhesives and used in the battery labels described herein. Examples of commercially available flame retardants include organic phosphates and phosphonates available under the designations AMGARD TOF, AMGARD CT, AMGARD DBBP, and AMGARD TBEP, from the Rhodia Group of Solvay Chemicals. Additional examples of suitable flame retardants include NuFR DOPO and NuFR DODP-HQ which are commercially available from NuTech Chemical, Limited.

The adhesive layer of the battery labels described herein has a thickness of from about 20 μm to about 100 μm.

The amount of flame retardant added or incorporated into the adhesive depends upon the end use application requirements and the characteristics of the adhesive and the retardant(s), among other factors. However, in certain embodiments the amount is from about 1% to about 40%, and more typically from about 5% to about 30%. The various battery labels described herein may use amounts of flame retardants greater than or less than these amounts.

Flame retardancy is assessed according to various industry standards and tests. A well recognized standard is UL94. This is a plastic flammability standard released by Underwriters Laboratories of the US. Tests are generally conducted on particular sized specimens having a certain thickness. Specific classifications apply to thin films such as battery labels. Table 2 set forth below lists parameters associated with three grades or levels of flame retardancy.

Specifically, vertical testing of thin materials is used for materials that are thin, or are too flexible or may distort, shrink or flex during ordinary vertical testing. The procedure for this testing is as follows. An 8 inch by 2 inch specimen is rolled longitudinally around a ½ inch diameter mandrel and taped on one end. When the mandrel is removed, the specimen forms a cone. The cone is supported in a vertical position and a flame is applied to the bottom of the specimen. The flame is applied for three seconds and then removed until flaming stops at which time the flame is reapplied for another three seconds and then removed. Two sets of five specimens are tested. The two sets are conditioned under different conditions.

TABLE 2
Flame Retardency Vertical Ratings for Thin Materials

| Vertical Rating | |
|---|---|
| for Thin | |
| Materials | Requirements |
| VTM-0 | Specimens must not burn with flaming combustion for more than 10 |
| | seconds after either test flame application. |
| | Total flaming combustion time must not exceed 50 seconds for each set of |
| | 5 specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 30 |
| | seconds after removal of the test flame. |
| | No specimen shall have flaming or glowing combustion up to a mark 5 |
| | inches from the bottom of the specimen. |
| VTM-1 | Specimens must not burn with flaming combustion for more than 30 |
| | seconds after either test flame application. |
| | Total flaming combustion time must not exceed 250 seconds for each set of |
| | 5 specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 60 |
| | seconds after removal of the test flame. |
| | No specimen shall have flaming or glowing combustion up to a mark 5 |
| | inches from the bottom of the specimen. |
| VTM-2 | Specimens must not burn with flaming combustion for more than 30 |
| | seconds after either test flame application. |
| | Total flaming combustion time must not exceed 250 seconds for each set of |
| | 5 specimens. |
| | Specimens must not burn with flaming or glowing combustion up to the |
| | specimen holding clamp. |
| | Specimens can drip flaming particles that ignite the cotton. |
| | No specimen can have glowing combustion remain for longer than 60 |
| | seconds after removal of the test flame. |
| | No specimen shall have flaming or glowing combustion up to a mark 5 |
| | inches from the bottom of the specimen. |

The representative battery labels exhibit a flame retardancy of at least VTM-2; in certain embodiments, VTM-1; and in many instances, VTM-0.

### Liner

A liner or layer of a liner material can be used to releasably cover the exposed face of the flame retardant layer. A wide array of liner materials can be used. A representative liner is a glassine material or polyethylene terephthalate (PET).

### Examples

A collection of flame retardant acrylic pressure sensitive adhesives useful for incorporating in the battery labels described herein were provided as follows.

Adhesive 1—an acrylic pressure sensitive adhesive having a total solids content of 39% to 42%, a Brookfield viscosity of 800 to 4500 mPa·s, a relative viscosity of 2.5 to 3.2, and a hydroxyl number of 120 to 160 mg KoH/g was combined with 5 to 30% by weight ammonium polyphosphate powder (flame retardant) by dispersing in the solvent acrylic adhesive. After 24 hours, samples of the adhesive exhibited a 90 degree peel test performance of greater than 8 N/in. Adhesive 1 is suitable for applications requiring high flame retardancy properties and typical heat resistance characteristics.

Adhesive 2—An acrylic pressure sensitive adhesive having a total solids content of 39% to 42%, a Brookfield viscosity of 800 to 4500 mPa·s, a relative viscosity of 2.0 to 4.0, a hydroxyl number of 60 to 80 mg KoH/g, an acid number of 10 to 50 mg KoH/g, and having aliphatic epoxy groups containing monomer that is copolymerized in the acrylic adhesive (to promote heat resistance properties), was combined with 5 to 30% by weight ammonium polyphosphate powder by dispersing in the solvent acrylic adhesive. After 24 hours, samples of the adhesive exhibited a 90 degree peel test performance of greater than 8 N/in. Adhesive 2 is suitable for applications requiring a good balance between flame retardancy and heat resistance.

Adhesive 3—An acrylic pressure sensitive adhesive having a total solids content of 35% to 37%, a Brookfield viscosity of 1000 to 3300 mPa·s, a relative viscosity of 2.5 to 4.0, an acid number of 30 to 50 mg KoH/g, and having aliphatic epoxy groups containing monomer that is copolymerized in the acrylic adhesive, was combined with 5 to 30% by weight ammonium polyphosphate powder dispersed in the solvent acrylic adhesive. After 24 hours, samples of the adhesive exhibited a 90 degree peel test performance of greater than 8 N/in. Adhesive 3 is suitable for applications requiring typical flame retardancy and relatively high heat resistance.

Many other benefits will no doubt become apparent from future application and development of this technology.

As described hereinabove, the present subject matter overcomes many problems associated with previous labels and labeled batteries. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. A battery label comprising:
a polyimide substrate defining an outer face and an oppositely directed inner face;
a layer of a flame retardant pressure sensitive adhesive disposed on the inner face of the polyimide substrate.

2. The battery label of claim 1 wherein the polyimide substrates comprises an inorganic pigment dispersed throughout the substrate.

3. The battery label of claim 2 wherein the inorganic pigment is carbon black.

4. The battery label of claim 3 wherein the concentration of carbon black in the polyimide substrate is from 1% to 2%.

5. The battery label of claim 2 wherein the polyimide substrate exhibits a black color.

6. The battery label of claim 1 wherein the polyimide substrate is formed from polymerizing pyromelletic dianhydride and 4,4′-oxydianiline.

7. The battery label of claim 1 wherein the thickness of the polyimide substrate is from about 35 μm to about 42 μm.

8. The battery label of claim 1 any one of claims 1 wherein the thickness of the polyimide substrate is from about 13 μm to about 17 μm.

9. The battery label of claim 1 further comprising:
a top coat layer disposed on the outer face of the polyimide substrate.

10. The battery label of claim 9 wherein the thickness of the top coat layer is from about 0.5 μm to about 5 μm.

11. The battery label of claim 1 wherein the flame retardant pressure sensitive adhesive comprises:
an acrylic adhesive; and
at least one flame retardant agent.

12. The battery label of claim 11 wherein the flame retardant agent is selected from the group consisting of metal oxide hydrates, polyphosphates, melamines, polysiloxanes, organic phosphonates, and combinations thereof.

13. The battery label of claim 1 wherein the layer of the flame retardant pressure sensitive adhesive has a thickness of from about 20 μm to about 100 μm.

14. The battery label of claim 1 wherein the label exhibits a flame retardancy of at least VTM-2.

15. The battery label of claim 1 wherein the label exhibits a flame retardancy of at least VTM-1.

16. The battery label of claim 1 wherein the label exhibits a flame retardancy of at least VTM-0.

17. A battery and label applied thereto comprising:
a battery having an outer surface; and
the battery label of claim 1 adhesively attached to the outer surface of the battery.

18. A multilayer flame retardant battery label exhibiting a black appearance and free of inks, coatings, or paints which are black in color.

19. The multilayer battery label of claim 18 comprising:
a substrate defining an outer face and an oppositely directed inner face; and
a layer of a flame retardant pressure sensitive adhesive disposed on the inner face of the substrate.

20. The multilayer battery label of claim 19 wherein the substrate comprises a polyimide.
